(19) United States
(12) Patent Application Publication
(10) Pub. No.: US 2026/0009925 A1
(43) Pub. Date: Jan. 8, 2026

(54) MACHINE LEARNING BASED FORMATION EVALUATION

(71) Applicant: Schlumberger Technology Corporation, Sugar Land, TX (US)

(72) Inventors: Xiaoyan ZHONG, Sugar Land, TX (US); Yong CHANG, Sugar Land, TX (US); Jithin Jith CHAKKUNGAL THODIKAYIL, Sugar Land, TX (US); Jianguo LIU, Sugar Land, TX (US); Keli SUN, Sugar Land, TX (US); Joseph GREMILLION, Sugar Land, TX (US); Xiao Bo HONG, Sugar Land, TX (US); Denis HELIOT, Sugar Land, TX (US); Sepand OSSIA, Sugar Land, TX (US)

(21) Appl. No.: 19/123,784

(22) PCT Filed: Nov. 1, 2023
(86) PCT No.: PCT/US2023/036610

§ 371 Date: Apr. 24, 2025

Related U.S. Application Data
(60) Provisional application No. 63/387,124, filed on Dec. 13, 2022.

(51) Int. Cl. G01V 3/30; G01V 3/34; G01V 3/38

(52) U.S. Cl. CPC G01V 3/30; G01V 3/34; G01V 3/38

(57) ABSTRACT

A method for classifying a subterranean formation includes deploying an electromagnetic logging tool in a wellbore penetrating the subterranean formation, causing the electromagnetic logging tool to make electromagnetic logging measurements in the wellbore, and evaluating the electromagnetic logging measurements with a trained machine learning primary classifier to classify the subterranean formation as either a 1D formation or a non-1D formation.

### CROSS REFERENCE TO RELATED APPLICATIONS

This application claims the benefit of U.S. Provisional Application No. 63/387,124, entitled “MACHINE LEARNING BASED FORMATION EVALUATION,” filed Dec. 13, 2022, the disclosure of which is hereby incorporated herein by reference.

### BACKGROUND

The use of electromagnetic (EM) measurements is well known in the oilfield industry. Both logging while drilling (LWD) and wireline logging techniques are commonly utilized to determine electromagnetic properties of a subterranean formation, which, along with porosity measurements, may indicate the presence of hydrocarbons in the formation. Moreover, EM LWD measurements are commonly employed in geosteering operations to provide information upon which drill bit steering decisions may be made. In such operations, a one-dimensional (1D) inversion model is generally used to evaluate the EM measurements and to provide real time feedback for geosteering. For example, in some operations the EM measurements may indicate a distance to a reservoir boundary. The intent of the geosteering operation may be to steer the direction of drilling such that the wellbore remains in the reservoir (e.g., at some desired distance above or below the boundary).

As stated above, commercial geosteering operations generally make use of a 1D inversion model. While such models can work well for simple layered formations in which the wellbore trajectory intercepts the layers or is directed within one of the layers, they tend to be inadequate for more complex formation structures, such as faults and structures having non-planar boundaries. The use of 2D, 2.5D, and 3D forward and inversion models are known, however, such models require more extensive data and time intensive computations and are therefore not suitable for practical geosteering operations. There remains a need in the industry for improvements that enable geosteering in complex formation structures.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling system including a disclosed electromagnetic LWD tool.

FIG. 2 depicts one example embodiment of the LWD tool shown on FIG. 1.

FIGS. 3A and 3B (collectively FIG. 3) depict flow charts of disclosed method embodiments for classifying a subterranean formation.

FIGS. 4A and 4B (collectively FIG. 4) depict example 1D formations including a planar layered structure.

FIGS. 5A, 5B, 5C, and 5D (collectively FIG. 5) depict example non-1D formations including faults (5A and 5B) and nonplanar boundary layers (5C and 5D).

FIG. 6 depicts a flow chart of example machine learning training methodologies.

FIGS. 7A and 7B (collectively FIG. 7) depict plots of accuracy and recall versus a distance of a transmitter to a fault for classifiers trained using the methodology shown in FIG. 6.

FIG. 8 depicts a flow chart of a disclosed deep learning training methodology.

FIGS. 9A and 9B (collectively FIG. 9) depict plots of accuracy and recall versus a distance of a drill bit to a fault for deep learning classifiers trained using the methodology shown in FIG. 8.

### DETAILED DESCRIPTION

Embodiments of this disclosure include systems and methods for classifying a subterranean formation. One example method includes deploying an electromagnetic logging tool in a wellbore penetrating the subterranean formation; causing the electromagnetic logging tool to make electromagnetic logging measurements in the wellbore; and evaluating the electromagnetic logging measurements with a trained machine learning primary classifier to classify the subterranean formation as either a 1D formation or a non-1D formation.

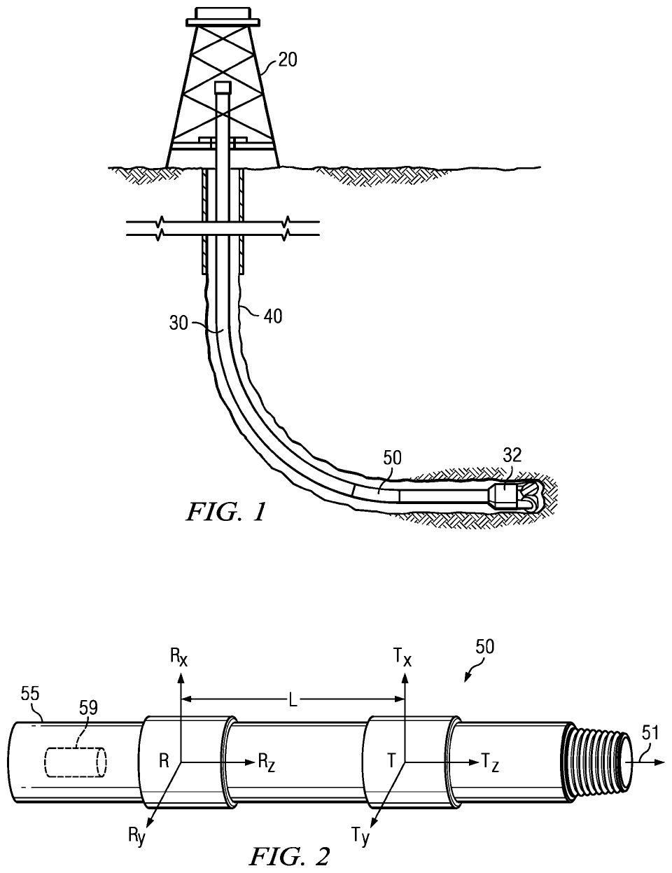

FIG. 1 depicts a drilling rig 20 including a drill string 30 and an example EM LWD tool 50 deployed in the string 30 and disposed within a wellbore 40. The drilling rig 20 may be deployed onshore or offshore (an onshore application is depicted). As is known to those of ordinary skill, offshore rigs commonly include a platform deployed atop a riser that extends from the sea floor to the surface. The drill string extends downward from the platform, through the riser, and into the wellbore through a blowout preventer (BOP) located on the sea floor. The disclosed embodiments are not limited in these regards. In both onshore and offshore operations, the wellbore 40 may be drilled in the subterranean formations via rotary drilling, slide drilling, or power drilling in a manner that is well-known to those of ordinary skill in the art (e.g., via well-known directional drilling techniques).

In the illustrated embodiment, the EM tool 50 is commonly deployed in a bottom hole assembly (BHA) including other downhole tools. The BHA may further include, for example, a rotary steerable system (RSS), a motor, drill bit 32, a measurement while drilling (MWD) tool, and/or one or more other LWD tools. The other LWD tools may be configured to measure one or more other properties of the formation through which the wellbore penetrates, for example, including NMR relaxation times, density, porosity, sonic velocity, gamma ray counts, and the like. A suitable MWD tool may be configured to measure one or more properties of the wellbore 40 as it is drilled or at any time thereafter. The physical properties may include, for example, pressure, temperature, wellbore caliper, wellbore trajectory (attitude), a toolface angle, and the like.

It will, of course, be understood that the disclosed embodiments are not limited to any particular BHA configuration. Nor are they limited to any particular type of drilling operation. Moreover, while geosteering applications are limited to LWD applications, the disclosed methods are not necessarily limited to geosteering or logging while drilling applications (as depicted on FIG. 1), but may also be implemented in wireline logging applications.

FIG. 2 depicts one example embodiment of EM LWD tool 50. In the depicted embodiment, the tool 50 includes at least one transmitter T and at least one receiver R axially spaced apart from one another on a tool collar 55 (by a spacing distance L). The tool collar 55 and any optional internal mandrel or external stabilizer blades may be referred to collectively herein as a tool body. Common electromagnetic logging tools include multiple spaced apart transmitters and receivers having various configurations. Examples of suitable electromagnetic logging tools include, but are not limited to, PeriScope™, ARC™, IMPulse™, EcoScope™, CDR™, MCR™, GeoSphere™, and IriSphere™ which are available from Schlumberger®.

The transmitter T and receiver R may include substantially any EM transmitter and receiver components suitable for use in a downhole tool (e.g., in an LWD tool). While not limited in this regard, it may be advantageous in certain embodiments to employ transmitter and receiver configurations that enable directional measurements such as voltage tensor measurements (or partial voltage tensor measurements) to be made. In the depicted example, the transmitter T and receiver R each may each include a triaxial antenna arrangement (e.g., three mutually orthogonal antennas including an axial antenna and first and second transverse antennas that are orthogonal to one another in this particular embodiment). For example, the transmitter and receiver may each include three collocated antennas having mutually orthogonal moments Tₓ, T_{y}, T_{z} and Rₓ, R_{y}, R_{z} that are aligned with corresponding x-, y-, and z-directions (axes) in the wellbore or tool reference frames. In another triaxial arrangement, the transmitter and/or receiver may include three rotationally offset tilted antennas (e.g., rotationally offset by 120 degrees from one another). By collocated it is meant that the axial spacing of the antenna moments is generally less than the diameter of the tool collar on which they are deployed. While the disclosed embodiment depicts a configuration in which the z-direction is aligned with the tool axis 51, it will be understood that the disclosed embodiments are not limited to any particular coordinate system or any particular orientation of the coordinate system (e.g., any particular orientation of the x-, y-, and z-axes on the tool).

The disclosed embodiments are, of course, not limited to any particular transmitter and receiver configurations on the tool collar. The transmitter(s) may be deployed above (up hole from), below (down hole from), and/or interspersed with the receiver(s). Nor are the disclosed embodiments limited to any particular antenna arrangements within the transmitters and receivers or to the use of collocated transmitting and/or receiving antennas as depicted. The transmitter T and receiver R may include substantially any suitable antenna configurations, for example, including axial, transverse, and/or tilted antenna arrangements. As is known to those of ordinary skill in the art, an axial antenna is one having a moment (e.g., T_{z} and R_{z} in FIG. 2) that is substantially parallel with the tool axis 51. Axial antennas are commonly wound about the circumference of the collar 55 such that the plane of the antenna is substantially orthogonal to the tool axis 51. Transverse antennas are antennas having moments (e.g., Tₓ, T_{y} and Rₓ, R_{y} in FIG. 2) that are perpendicular with the tool axis. A transverse antenna may include a conventional transverse antenna arrangement, for example, including a saddle coil. A tilted antenna is one whose magnetic moment is neither parallel nor perpendicular with the axis of the tool (and may be tilted, for example, at an angle of about a 45-degree with respect to the tool axis). Axial, transverse, and tilted antennas are well known and in commercial use in the industry.

It will be appreciated that the disclosed embodiments may also be well suited for use with deep EM LWD measurements. Thus, while not depicted in FIG. 2, it will be understood that for a deep reading EM tool the transmitter T and receiver R may be deployed on corresponding first and second distinct subs (or distinct tool collars) that may be separated by a substantial distance along the length of the BHA and that other BHA tools, e.g., including other logging tools, may be deployed between the subs. Despite the optional separation of the transmitter and receiver on distinct subs and the deployment of other downhole tools and sensors therebetween, for convenience the combined transmitter/receiver assembly is referred to herein as an EM logging tool having a tool body (or logging while drilling tool body).

With continued reference to FIG. 2, EM tool 50 may include a controller 59 (including one or more processors) configured to make EM measurements, for example, via firing the transmitting antennas and receiving corresponding voltages at the receiving antennas. The controller may be further be configured to process the received voltages and construct the electromagnetic measurements (e.g., including the raw voltages, voltage coefficients, attenuation, phase shift, and the like). The controller may further be configured to evaluate the electromagnetic measurements with a trained machine learning model to classify the subterranean formation as described in more detail below. To perform these functions, the controller may include one or more processors (e.g., microprocessors) which may be in communication with one or more data storage devices (e.g., electronic or solid state memory). Moreover, the controller may be in communication with other downhole controllers and processors deployed elsewhere in the drill string (such as a steering tool controller). It will, of course, be understood that the disclosed embodiments are not limited the use of or the configuration of any particular computer hardware and/or software.

It will be appreciated that EM logging measurements may be made by electromagnetically coupling an EM transmitting antenna with one or more receiving antennas. Coupling an EM transmitting antenna and one or more receiving antennas may be accomplished by applying a time varying electrical current (an alternating current) to the transmitting antenna to transmit EM energy into the surrounding environment (including the formation). This is referred to as “firing” the transmitter. The transmitted energy generates a corresponding time varying magnetic field in the local environment (e.g., in the tool collar, borehole fluid, and formation). The magnetic field in turn induces electrical currents (eddy currents) in the conductive formation. These eddy currents further produce secondary magnetic fields which may produce a voltage response in a receiving antenna (the EM energy is received, for example, via measuring the complex-valued voltage in the receiving antenna). Therefore, in example embodiments, acquiring or making electromagnetic measurements may be understood to mean firing a transmitting antenna and receiving corresponding voltages at one or more receiving antennas (e.g., while drilling).

The disclosed embodiments may make use of substantially any suitable downhole EM measurements, for example including EM induction measurements and/or EM propagation measurements. As is known to those of ordinary skill in the art, commercial induction measurements are commonly made at a frequency in a range from about 10 kHz to about 100 kHz. In-phase and quadrature (out-of-phase) voltage signals may be measured at each receiver. These voltage signals may be related to an apparent resistivity, for example, by dividing the voltage by a tool constant. Commercial propagation measurements are commonly made at higher frequencies, for example, in a range from about 100 kHz to about 2 MHz. A propagation measurement generally includes a logarithm of a ratio of at least first and second voltage measurements, for example, as follows: AT+iPS=ln(V₁/V₂) where V₁ and V₂ represent first and second voltage measurements obtained from first and second distinct transmitter receiver couplings (e.g., made at first and second receiving antennas), and AT and PS represent the attenuation and phase shift of the voltage measurement. Those of ordinary skill in the art will readily appreciate that such measurements are commonly made while rotating and translating an EM logging tool in a wellbore to obtain a plurality of measurements made at a plurality of corresponding measured depths (e.g., while drilling). The measurements may be plotted versus measured depth to generate a log or versus measured depth and toolface angle to generate an image.

During a logging operation the antenna voltages may be measured as the tool rotates (e.g., during drilling). The measured voltages may be fit to a function of the rotation angle θ (also referred to as the toolface angle or the azimuth angle), for example, to obtain average (DC), first-harmonic cosine (FHC), first harmonic sine (FHS), second harmonic cosine (SHC), and second harmonic sine (SHS) voltage coefficients as follows:

$${V}_{i j} = {V}_{D C} + {V}_{F H C} cos ( θ ) + {V}_{F H S} sin ( θ ) + {V}_{S H C} cos ( 2 θ ) + {V}_{S H S} sin ( 2 θ )$$

Where Vᵢⱼ represents the measured voltages and the coefficients i and j represent the transmitting and receiving antennas. It will be appreciated that Vᵢⱼ may include, for example, a 3×3 voltage tensor and that each of the voltage coefficients may also include a 3×3 tensor (e.g., in which i and j can each be x, y, or z). It will further be appreciated that these voltage coefficients, or the attenuation and phase shift of these voltage coefficients, may be considered to be the electromagnetic measurements or the “measured” voltages at each point or depth in a log. Likewise. the attenuation and phase shift of each of these voltage coefficients may be considered to the be electromagnetic measurements.

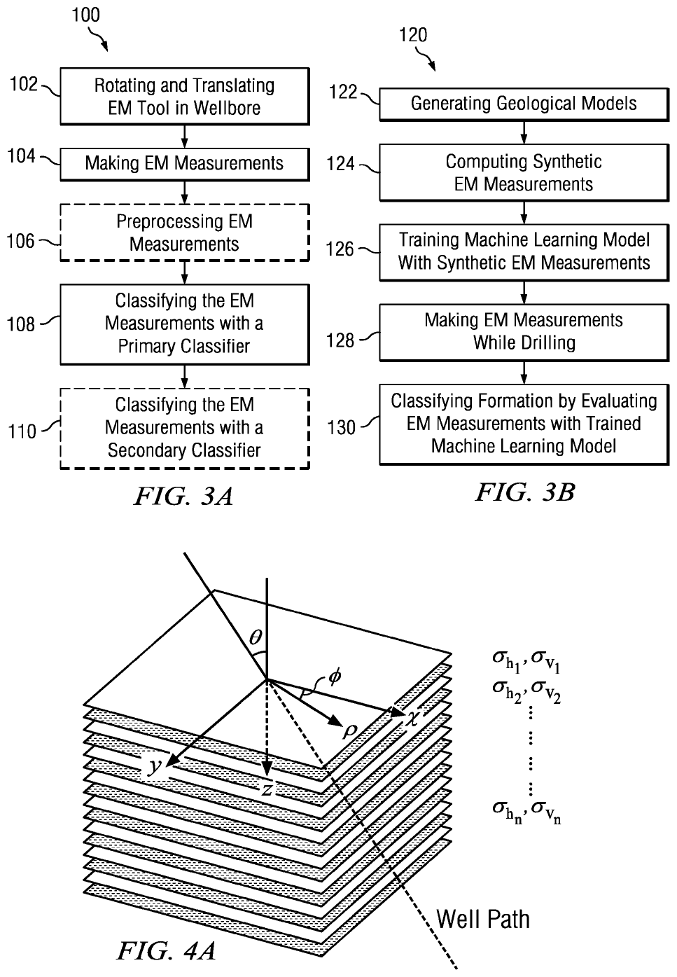

Turning now to FIGS. 3A and 3B, flow charts of example methods 100 and 120 for evaluating a formation are depicted. In FIG. 3A, method 100 includes deploying an EM logging tool in a wellbore at 102 (e.g., rotating and translating the tool in the wellbore while drilling the well). The method 100 further includes causing the tool to make EM measurements at 104, for example, to generate a log of EM measurements such as a plot or listing of the EM measurements with depth or time. The EM measurements may include substantially any suitable EM measurements as described above, but may advantageously include a 3×3 voltage tensor or a portion thereof (as also described above). The EM measurements may be optionally preprocessed at 106. Such preprocessing may include, for example, low pass filtering to remove measurement noise and normalization with maxima and minima scaling.

The EM measurements (or the preprocessed measurements) may then be processed at 108 using a trained machine learning model to classify the formation with a primary classifier. In one example embodiment, the primary classifier classifies the formation as a 1D formation or a non-1D formation. By classifying the formation as a 1D formation it may be meant that the EM measurements or log may be inverted using a 1D inversion algorithm to achieve a formation model having an error less than a predetermined threshold. For example, the formation may be accurately approximated as including a plurality of simple parallel layers or as being homogeneous. By classifying the formation as a non-1D formation it may be meant that the EM measurements or log cannot be inverted using a 1D inversion algorithm (or that using a 1D inversion results in errors that exceed the threshold). For example, the formation may be understood to have a more complex structure than a plurality of simple parallel layers.

With continued reference to FIG. 3A, when the formation is classified as non-1D, the EM measurements may be further processed at 110 using the same or another trained machine learning model to classify the formation with a secondary classifier. The secondary classifier may further classify the non-1D formation as being in one of a plurality of non-1D formation types, for example, including a fault such as an up-fault or a down-fault, water coning, or sand injectite. The disclosed embodiments are, of course, not limited to the above list of non-1D formation types. As described in more detail below, the EM measurements may be processed point by point (or depth by depth) at 108 and 110 (e.g., in real time while drilling the well) or in sets of multiple points (or depths) that make up portions of a log may be processed at 108 and 110. The disclosed embodiments are not limited in this regard.

Turning now to FIG. 3B, method 120 is similar to method 100 but further includes training a machine learning model. The method 120 includes generating a large number of geological models at 122. The generated models may include 1D and/or non-1D formation structures. The models including 1D formation structures generally include layered formations with the layers having various resistivity values and thicknesses. These models may further include wellbores having a range of trajectories, for example, from horizontal to near vertical. The non-1D formation structures may include more complex formation structures including, for example, faults, water coning, and injectite structures. Synthetic EM measurements (or measurement logs) are computed at 124 by processing the models generated at 122 with a forward model, for example, a 2.5D or 3D forward model. It will be appreciated that the synthetic EM measurements may be generated with and/or without realistic noise.

With continued reference to FIG. 3B, the synthetic EM measurements having a known and labeled formation structure may be processed with a machine learning model at 126, for example, to develop a correlation between features of the measurements and the formation structure to thereby generate and/or train a model. The processing at 126 may include evaluating the EM measurements to identify correlations between the labeled formation types and features of the EM measurements. Such features may include, for example, magnitudes of the individual tensor components of the measurements, sums, differences, or ratios of various tensor components, and/or other functions of the tensor components. These features may be scaled or standardized to ensure uniformity between different formations. It will be appreciated that the EM measurement features that best correlate with formation structure may be automatically selected by the machine learning model, for example, via a feature importance study. Certain measurement features may also be manually selected. Model training at 126 may further include verifying, updating, and/or retraining the model, for example, via field testing using synthetic and/or actual EM data. It will be appreciated that while the above embodiments make use of synthetic data to train the model at 126 that disclosed embodiments may alternatively and/or additionally make use of actual EM data to train the model at 126 (e.g., field test data and/or LWD data obtained during a drilling operation).

With still further reference to FIG. 3B, the trained model may be used in a logging while drilling operation to evaluate a subterranean formation as described above with respect to method 100 (FIG. 3A). For example, EM measurements may be acquired while drilling at 128 and evaluated with the trained machine learning model at 130 to classify a subterranean formation through which the drilled wellbore penetrates. The classification may include, for example, a primary classification which identifies the formation as a 1D formation or non-1D formation and a secondary classification that identifies non-1D formations with a further classification such as an up-fault, a down-fault, a water coning, or an injectite structure.

It will be understood that even after successfully field testing the machine learning model, it may from time to time fail to accurately label a subterranean formation. In such instances, the EM measurement data may be relabeled with a known or estimated formation structure. The relabeled measurements may then be used to further update and/or train the model in a manner similar to that described above at 126.

With continued reference to FIGS. 3A and 3B, it will be appreciated that while not depicted, the methods may further include utilizing the primary and/or secondary formation classifications to assist in a geosteering operation. For example, when the primary classification labels the formation as 1D, the EM measurements may be processed using a 1D inversion algorithm. In such embodiments, the 1D inversion may be automatically processed downhole (e.g., in the EM LWD tool controller). The inversion results (e.g., a distance to a boundary) may be transmitted to a steering tool controller in the BHA where they may be further processed to update the direction of drilling and corresponding steering tool settings (e.g., using techniques known to those of ordinary skill). In alternative embodiments, selected EM measurements may be transmitted to the surface (e.g., via known telemetry techniques) and processed using a 1D inversion algorithm. The inversion results may then be further processed to obtain updated steering tool settings which may then be downlinked to the steering tool.

When the formation is labeled as non-1D, more complex inversion algorithms (e.g., 2D, 2.5D or 3D) may be invoked. In certain embodiments, the tool controller may be configured to automatically transmit more extensive EM measurements to the surface for such higher order inversion processing. Updated steering tool settings may then be downlinked to the steering tool. The controller may be further configured to automatically resume use of the 1D inversion when the formation is again classified as 1D. In other embodiments, the tool controller may be configured to automatically select or specify specialized higher order inversion algorithms based on the secondary classification. For example only, a specialized higher order up-fault algorithm may be selected when the secondary classification indicates an up-fault formation. In such embodiments, the specialized inversion processing may be performed downhole or at the surface depending on the processing power of the controller and the details of the secondary classification.

With continue reference to FIG. 3, the primary classifier and the second classifier used in methods 100 and 120 may make use of distinct machine learning models. For example, the primary classifier may make use of an anomaly detection algorithm. In such embodiments, the machine learning model may be trained using synthetic data generated using only 1D formation models (i.e., formation models including a plurality of planar layers). EM measurement data may then be classified as regular or similar to the training data (1D) or an anomaly in that it is different than the training set (non-1D). The primary classifier may make use of an unsupervised anomaly (or outlier) detection methods to determine whether or not the EM measurements conform to the training data set. EM measurements that conform to the training data set may be indicative of a 1D formation while EM measurements that do not conform to the training data may be indicative of a non-1D formation. Substantially any suitable anomaly detection methods may be used, for example, including one class support vector method (OC-SVM), local outlier factor (LOF), isolation forest, or a deep learning auto-encoder.

In other embodiments, the primary classifier may make use of a binary classification algorithm. In such embodiments, the machine learning model may be trained using synthetic data generated using both 1D and non-1D formation models in which the models are labeled with one of two classes (either 1D or non-1D). As described above, substantially any suitable non-1D formation types may be included in the model training, for example, including faults (such as up-faults and down-faults) and non-planar or non-flat layers (such as water coning and injectite). In training the primary classifier, these different types of non-1D formations may all be labeled with the same class (non-1D). Substantially any suitable binary classification methods may be used, for example, including support vector machine (SVM), random forest, times series forest, and a deep learning multilayer perceptron classifier (MLPC).

The secondary classifier may make use of a multiclass classification method. In one example embodiment, the machine learning model may be trained using synthetic data generated using only non-1D formation models in which the models are labeled with a particular non-1D structure, for example, including up-fault, down-fault, water coning, sand injectite, and the like. The disclosed embodiments are, of course, not limited in these regards.

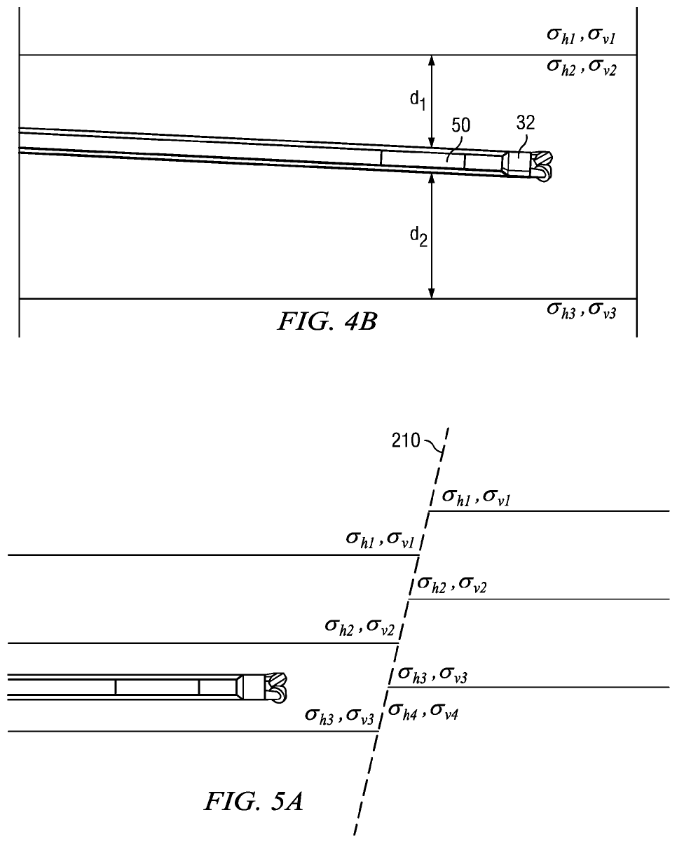

Turning now to FIGS. 4A and 4B (collectively FIG. 4), example regular (1D) formation structures are depicted. In FIG. 4A the formation includes a planar layered structure in which an anisotropic formation conductivity σₕ and σᵥ may change in a direction perpendicular to the layers (the z-direction), but is unchanged within each layer (is invariant in both the x- and y-directions). Angles θ and ϕ are the relative dip and azimuth of the well path and h represents the thickness of the individual layers.

In FIG. 4B, the direction of drilling is nearly parallel with one of the layers. Again, the formation includes a planar layered structure in which an anisotropic formation conductivity σₕ and σᵥ may change from layer to layer, but is unchanged within each layer. The position of the wellbore may be further defined with respect to the distances d₁ and d₂ between the EM LWD tool 50 and upper and lower formation layer boundaries (where h≈d₁+d₂).

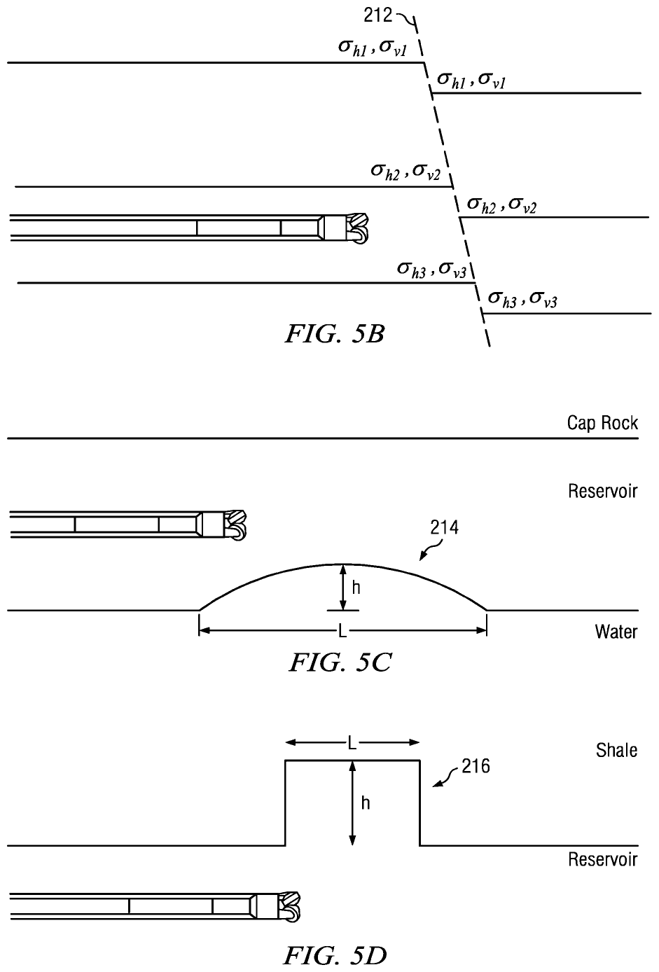

FIGS. 5A-5D depict example non-1D formation structures. FIGS. 5A and 5B depict two common planar faults (also referred to as planar discontinuities). In such formation structures, there is a discontinuity of the formation layers along a planar fracture (referred to herein as a fault). As described above for the regular (1D) formation, the formation includes a layered structure in which each layer may have a unique anisotropic formation conductivity σₕ and σᵥ. In FIG. 5A, the formation further includes fault 210 that shifts the layers upwards on the right side of the figure. This results in an up-fault when drilling from left to right. In FIG. 5B, the formation further includes fault 212 that shifts the layers downwards on the right side of the figure. This results in a down-fault when drilling from left to right. It will be appreciated that when drilling through such formations, that the EM measurements may deviate from expected 1D behavior as the wellbore approaches the faults 210, 212. Moreover, the distance to the fault and the magnitude of the fault (the size of the shift) may be valuable information for the directional driller during a drilling operation. It will be still further appreciated that the direction of drilling may need to be steered upward to remain in a reservoir layer when drilling through an up-fault and may need to be steered downward to remain in a reservoir layer when drilling through a down-fault.

FIGS. 5C and 5D depict examples of non-planar formation layers. As described above for the regular (1D) formation, the formation may include a layered structure in which each layer may have a unique anisotropic formation conductivity σₕ and σᵥ, however, a boundary between adjacent ones of the layers is non-planar. In FIG. 5C, reservoir layer is located between an upper cap rock and a lower water layer. In a water coning structure (as depicted), the oil-water contact profile may become nonplanar due to nearby production activity or local pressure anomalies. The size and severity of the water cone 214 may be defined by its height h and length (or width or diameter) L. In FIG. 5D, a sandstone reservoir layer is located below a shale layer. In a sand injectite structure (as depicted), a sandstone intrusion into the shale layer may result in a nonplanar boundary (e.g., as shown). The size of the injectite 216 may be defined by its height h and length (or width or diameter) L. It will be appreciated that when drilling through such formations, that the EM measurements may deviate from expected 1D behavior as the wellbore approaches the nonplanar structures 214, 216. Moreover, the distance to the nonplanar structure and the size thereof may be valuable information for the directional driller during a drilling operation. It will be still further appreciated that the direction of drilling may need to be steered or remain the same depending on the type of and the size and shape of the nonplanar structure. For example, the drilling direction may be steered upward to avoid a large water cone. However, it may be desirable for the direction of drilling to remain unchanged in the presence of a sand injectite (even though the apparent distance to the shale boundary can increase significantly).

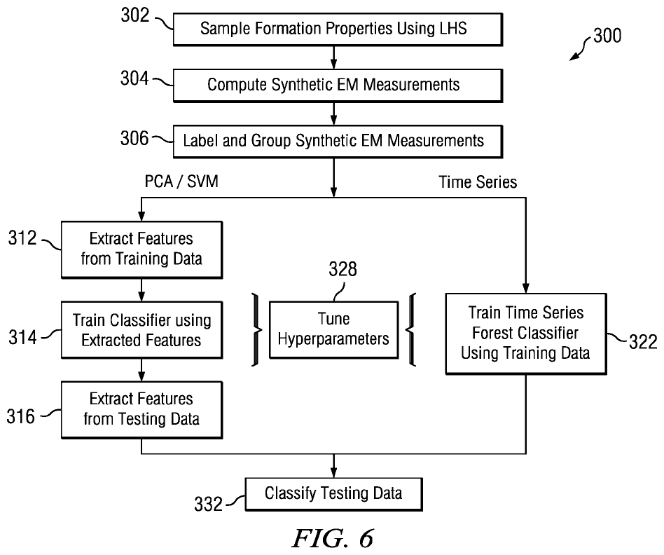

The disclosed embodiments are described in more detail by way of the following non-limiting example. In this example, a primary classifier was trained and evaluated using first and second distinct binary classification methods, namely SVM and Time Series Forest. FIG. 6 depicts a flow chart of the example training methodology 300 used in this example. Formation properties were sampled using the Latin Hypercube Sampling (LHS) method at 302 to obtain a near random sampling of formation parameter values and thereby generate a large number of 1D and non-1D formation models. Synthetic EM measurements were computed at 304 for the models generated at 302 using a 2.5D forward model. In this example, the synthetic data included harmonic voltage coefficients computed at depth intervals along a wellbore traversing the formation model. The synthetic data was labeled (as 1D or non-1D) and split into a training set (80% of the synthetic measurements) and a testing set (20% of the synthetic measurements) at 306.

With continued reference to FIG. 6, features were extracted from the synthetic training data at 312 by linearly transforming the synthetic data into a new coordinate system to enhance variation in the data using principal component analysis (PCA). A binary classification primary classifier (machine learning model) was then trained using the extracted features and SVM at 314. The features were also extracted from the testing data at 316. The synthetic training data was also processed to train a second primary classifier at 322 using a Time Series Forest binary classification method. A grid search cross validation was then performed at 328 to tune the machine learning hyperparameters. The testing data was then evaluated at 332 using the first and second trained binary classification algorithms. The PCA/SVM methodology was found to be faster for both training and testing. The Time Series Forest method was found to be more accurate (especially for small training windows in the presence of noise) at identifying a fault as a non-1D formation.

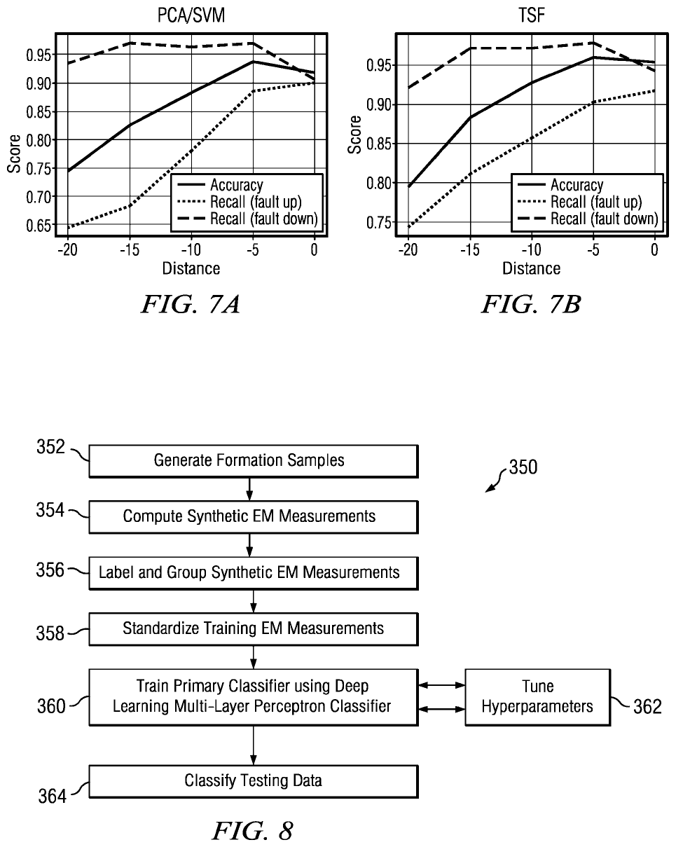

The example results are described in more detain with respect to FIGS. 7A and 7B (collectively FIG. 7) which depict plots of accuracy and recall versus the distance of the transmitter to a fault in models used to generate the testing data. In these plots the accuracy is defined as the fraction of correctly predicted samples while the recall is defined as the ability of the classifier to identify the positive samples (i.e., a ratio of the true positives to a sum of the true positives and the false negatives). FIG. 7A depicts test results for the PCA/SVM algorithm while FIG. 7B depicts test results for the Time Series Forest algorithm. In FIG. 7A, the accuracy is about 75% at a distance of 20 meters from the fault and increases to over 90% as the distance decreases to 5 meters. The recall for down-faults is greater than 90% at all distances while the recall for up-faults increases from about 65% at a distance of 20 meters to nearly 90% at a distance of 5 meters. In FIG. 7B, the accuracy is about 80% at a distance of 20 meters from the fault and increases to over 95% as the distance decreases to 5 meters. The recall for down-faults is greater than 90% at all distances while the recall for up-faults increases from about 75% at a distance of 20 meters to about 90% at a distance of 5 meters.

FIG. 8 depicts a flow chart of an example deep learning training methodology 350 used in another example. A large number of 1D and non-1D formation samples (models) were generated at 352. Synthetic EM measurements were computed at 354 for the models generated at 352 using a 2.5D forward model. In this example, the synthetic logs included harmonic voltage coefficients computed at depth intervals along a wellbore traversing the formation model. The synthetic data was labeled (as 1D or non-1D) and split into a training set (70% of the synthetic measurements) and a testing set (30% of the synthetic measurements) at 356. The training data was standardized and a z-score computed for each EM measurement in the training set at 358. A primary classifier was trained at 360 using a deep learning multi-layer perceptron classifier (MLPC). Hyperparameters were tuned while training using a hyperband tuner at 362. The trained MLPC was then tested using the testing data set at 364.

With continued reference to FIG. 8, while training the MLPC at 360 it was found that the derivative (or slope) of the EM measurements with respect to the depth of the EM measurements in the wellbore was highly sensitive to changes in the formation, and particularly to approaching non-1D formation features such as faults and non-planar boundary features. In this example, first and second classifiers were trained. The first utilized the synthetic EM measurements point-by-point and trained the classifier without any depth information. This classifier is referred herein as a ‘point’ classifier. The second employed the EM logs including the depth information and trained the classifier using both the synthetic EM measurements and derivatives of the synthetic EM measurements with respect to depth. This classifier is referred to herein as a ‘slope’ classifier.

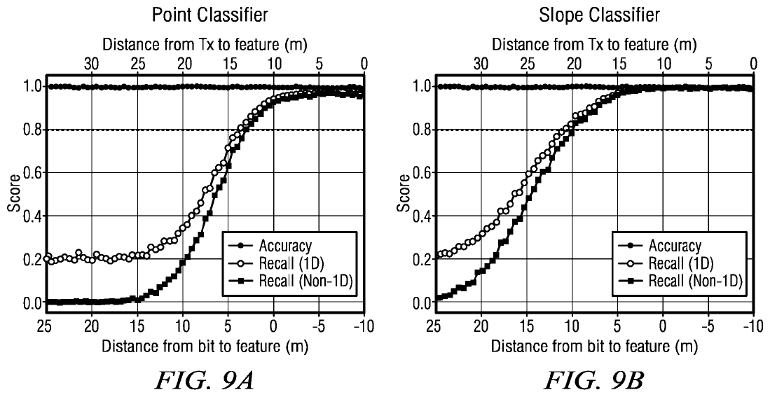

The results of this second example are described in more detain with respect to FIGS. 9A and 9B (collectively FIG. 9) which depict plots of accuracy and recall versus the distance of the drill bit (which was 10 meters below the transmitter) to a non-1D formation feature. In this example, the non-1D features included up-faults, down-faults, and non-planar or non-flat boundaries such as injectites and water coning. As in the previous example, accuracy is defined as the fraction of correctly predicted samples and recall is defined as the ability of the classifier to identify the positive samples. FIG. 9A depicts test results for the point classifier while FIG. 9B depicts test results for the slope classifier. In FIG. 9A, the accuracy and recall of the non-1D formation increased sharply as the bit approached the non-1D feature (from below 40% at 10 meters to greater than 80% at 3 meters). In FIG. 9B, the accuracy and recall of the non-1D formation also increased sharply as the bit approached the non-1D feature (from below 40% at 20 meters to greater than 80% at 10 meters and to nearly 100% at five meters). As evidenced by FIGS. 9A and 9B, both the point and slope classifiers achieved good look-ahead sensitivity (being able to identify the non-1D feature ahead of the bit) with the slope classifier being far superior. Both classifiers also achieved near 100% recall for 1D formations at all distances.

It will be understood that the present disclosure includes numerous embodiments. These embodiments include, but are not limited to, the following embodiments.

In a first embodiment, a method for classifying a subterranean formation comprises deploying an electromagnetic logging tool in a wellbore penetrating the subterranean formation; causing the electromagnetic logging tool to make electromagnetic logging measurements in the wellbore; and evaluating the electromagnetic logging measurements with a trained machine learning primary classifier to classify the subterranean formation as either a 1D formation or a non-1D formation.

A second embodiment may include the first embodiment, wherein the electromagnetic logging measurements comprise electromagnetic voltage coefficients.

A third embodiment may include any one of the first through second embodiments, wherein the trained machine learning primary classifier is trained using synthetic electromagnetic measurements generated with a forward model.

A fourth embodiment may include any one of the first through third embodiments, wherein the trained machine learning primary classifier comprises an anomaly detection algorithm that is trained using a training set of synthetic electromagnetic data generated from a set of formation models including only 1D formation models.

A fifth embodiment may include any one of the first through fourth embodiments, wherein the trained machine learning primary classifier comprises a binary classification algorithm that is trained using a training set of synthetic electromagnetic data generated from a set of formation models including both 1D formation models and non-1D formation models.

A sixth embodiment may include the fifth embodiment, the trained machine learning primary classifier is a deep learning slope classifier trained using synthetic electromagnetic measurements and derivatives of the synthetic electromagnetic measurements with respect to depth.

A seventh embodiment may include any one of the first through sixth embodiments, further comprising evaluating the electromagnetic logging measurements with a trained machine learning secondary classifier to classify the subterranean formation as being one of a plurality of non-1D formation types when the primary classifier classifies the subterranean formation as the non-1D formation.

An eighth embodiment may include any one of the first through seventh embodiments, wherein the evaluating is performed by a controller in the electromagnetic logging tool.

A ninth embodiment may include the eighth embodiment further comprising automatically processing the electromagnetic logging measurements with a 1D inversion when the subterranean formation is classified as the 1D formation to estimate at least one property of the subterranean formation; and evaluating the at least one property to change a direction of drilling of the wellbore.

A tenth embodiment may include the eighth embodiment, further comprising automatically flagging the electromagnetic measurements as non-1D when the subterranean formation is classified as the non-1D formation; and transmitting at least a portion of the flagged electromagnetic measurements to a surface location for higher order inversion processing.

In an eleventh embodiment an electromagnetic logging while drilling tool comprises a logging while drilling tool body; at least one transmitter and at least one receiver deployed on the logging while drilling tool body; and a controller configured to cause the at least one transmitter and at least one receiver to make electromagnetic measurements while the logging while drilling tool rotates in a wellbore penetrating a subterranean formation; and evaluate the electromagnetic measurements with a trained machine learning primary classifier to classify the subterranean formation as either a 1D formation or a non-1D formation.

A twelfth embodiment may include the eleventh embodiment, wherein the controller is further configured to evaluate the electromagnetic logging measurements with a trained machine learning secondary classifier to classify the subterranean formation as being one of a plurality of non-1D formation types when the primary classifier classifies the subterranean formation as the non-1D formation.

A thirteenth embodiment may include any one of the eleventh through twelfth embodiments, wherein the controller is further configured to automatically process the electromagnetic logging measurements with a 1D inversion when the subterranean formation is classified as the 1D formation to estimate at least one property of the subterranean formation.

A fourteenth embodiment may include any one of the eleventh through thirteenth embodiments, wherein the controller is further configured to automatically flag the electromagnetic measurements as non-1D when the subterranean formation is classified as the non-1D formation and transmit at least a portion of the flagged electromagnetic measurements to a surface location for higher order inversion processing.

A fifteenth embodiment may include any one of the eleventh through fourteenth embodiments, wherein the trained machine learning primary classifier is trained using synthetic electromagnetic measurements and derivatives of the synthetic electromagnetic measurements with respect to depth.

In a sixteenth embodiment a method for classifying a subterranean formation comprises generating a plurality of geological models; processing the geological models with a forward model to compute synthetic electromagnetic measurements; training a machine learning model with the synthetic electromagnetic measurements to generate a trained model; rotating and translating an electromagnetic logging tool in a wellbore penetrating the subterranean formation; causing the electromagnetic logging tool to make electromagnetic logging measurements while rotating and translating in the wellbore; and evaluating the electromagnetic logging measurements with the trained model to classify the subterranean formation as either a 1D formation or a non-1D formation.

A seventeenth embodiment may include the sixteenth embodiment, wherein the plurality of geological models includes only 1D formation models; and the machine learning model includes an anomaly detection algorithm.

An eighteenth embodiment may include any one of the sixteenth through seventeenth embodiments, wherein the plurality of geological models includes both 1D formation models and non-1D formation models; and the machine learning model includes a binary classification algorithm.

A nineteenth embodiment may include any one of the sixteenth through eighteenth embodiments, wherein training the machine learning model comprises training a first machine learning model to generate a primary classifier and training a second machine learning model to generate a secondary classifier; and evaluating the electromagnetic logging measurements comprises evaluating the electromagnetic logging measurements with the primary classifier to classify the subterranean formation as either the 1D formation or the non-1D formation and evaluating the electromagnetic logging measurements with the secondary classifier to classify the subterranean formation as being one of a plurality of non-1D formation types when the primary classifier classifies the subterranean formation as the non-1D formation.

A twentieth embodiment may include any one of the sixteenth through nineteenth embodiments, wherein the evaluating the electromagnetic logging measurements is performed by a controller in the electromagnetic logging tool and the method further comprises automatically processing the electromagnetic logging measurements with a 1D inversion to estimate at least one property of the subterranean formation when the subterranean formation is classified as a 1D formation; and automatically flagging the electromagnetic measurements as non-1D when the subterranean formation is classified as the non-1D formation and transmitting at least a portion of the flagged electromagnetic measurements to a surface location for higher order inversion processing.

Although machine learning based formation evaluation has been described in detail, it should be understood that various changes, substitutions and alternations can be made herein without departing from the spirit and scope of the disclosure as defined by the appended claims.

1. A method for classifying a subterranean formation, the method comprising:
deploying an electromagnetic logging tool in a wellbore penetrating the subterranean formation;
causing the electromagnetic logging tool to make electromagnetic logging measurements in the wellbore;
evaluating the electromagnetic logging measurements with a trained machine learning primary classifier to classify the subterranean formation as either a 1D formation or a non-1D formation; and
evaluating the electromagnetic logging measurements with a trained machine learning secondary classifier to classify the subterranean formation as being one of a plurality of non-1D formation types when the primary classifier classifies the subterranean formation as the non-1D formation.

2. The method of claim 1, wherein the electromagnetic logging measurements comprise electromagnetic voltage coefficients.

3. The method of claim 1, wherein the trained machine learning primary classifier is trained using synthetic electromagnetic measurements generated with a forward model.

4. The method of claim 1, wherein the trained machine learning primary classifier comprises an anomaly detection algorithm that is trained using a training set of synthetic electromagnetic data generated from a set of formation models including only 1D formation models.

5. The method of claim 1, wherein the trained machine learning primary classifier comprises a binary classification algorithm that is trained using a training set of synthetic electromagnetic data generated from a set of formation models including both 1D formation models and non-1D formation models.

6. The method of claim 5, wherein the trained machine learning primary classifier is a deep learning slope classifier trained using synthetic electromagnetic measurements and derivatives of the synthetic electromagnetic measurements with respect to depth.

7. (canceled)

8. The method of claim 1, wherein the evaluating is performed by a controller in the electromagnetic logging tool.

9. The method of claim 8, further comprising:
automatically processing the electromagnetic logging measurements with a 1D inversion when the subterranean formation is classified as the 1D formation to estimate at least one property of the subterranean formation; and
evaluating the at least one property to change a direction of drilling of the wellbore.

10. The method of claim 8, further comprising:
automatically flagging the electromagnetic measurements as non-1D when the subterranean formation is classified as the non-1D formation; and
transmitting at least a portion of the flagged electromagnetic measurements to a surface location for higher order inversion processing.

11. An electromagnetic logging while drilling tool comprising:
a logging while drilling tool body;
at least one transmitter and at least one receiver deployed on the logging while drilling tool body; and
a controller configured to:
cause the at least one transmitter and at least one receiver to make electromagnetic measurements while the logging while drilling tool rotates in a wellbore penetrating a subterranean formation; and
evaluate the electromagnetic measurements with a trained machine learning primary classifier to classify the subterranean formation as either a 1D formation or a non-1D formation, wherein the trained machine learning primary classifier is trained using synthetic electromagnetic measurements and derivatives of the synthetic electromagnetic measurements with respect to depth.

12. The electromagnetic logging tool of claim 11, wherein the controller is further configured to evaluate the electromagnetic logging measurements with a trained machine learning secondary classifier to classify the subterranean formation as being one of a plurality of non-1D formation types when the primary classifier classifies the subterranean formation as the non-1D formation.

13. The electromagnetic logging tool of claim 11, wherein the controller is further configured to automatically process the electromagnetic logging measurements with a 1D inversion when the subterranean formation is classified as the 1D formation to estimate at least one property of the subterranean formation.

14. The electromagnetic logging tool of claim 11, wherein the controller is further configured to automatically flag the electromagnetic measurements as non-1D when the subterranean formation is classified as the non-1D formation and transmit at least a portion of the flagged electromagnetic measurements to a surface location for higher order inversion processing.

15. (canceled)

16. A method for classifying a subterranean formation, the method comprising:
generating a plurality of geological models;
processing the geological models with a forward model to compute synthetic electromagnetic measurements;
training a machine learning model with the synthetic electromagnetic measurements to generate a trained model;
rotating and translating an electromagnetic logging tool in a wellbore penetrating the subterranean formation;
causing the electromagnetic logging tool to make electromagnetic logging measurements while rotating and translating in the wellbore; and
evaluating the electromagnetic logging measurements with the trained model to classify the subterranean formation as either a 1D formation or a non-1D formation, wherein the evaluating the electromagnetic logging measurements is performed by a controller in the electromagnetic logging tool and the method further comprises:
automatically processing the electromagnetic logging measurements with a 1D inversion to estimate at least one property of the subterranean formation when the subterranean formation is classified as a 1D formation; and
automatically flagging the electromagnetic measurements as non-1D when the subterranean formation is classified as the non-1D formation and transmitting at least a portion of the flagged electromagnetic measurements to a surface location for higher order inversion processing.

17. The method of claim 16, wherein:
the plurality of geological models includes only 1D formation models; and
the machine learning model includes an anomaly detection algorithm.

18. The method of claim 16, wherein:
the plurality of geological models includes both 1D formation models and non-1D formation models; and
the machine learning model includes a binary classification algorithm.

19. The method of claim 16, wherein:
training the machine learning model comprises training a first machine learning model to generate a primary classifier and training a second machine learning model to generate a secondary classifier; and
evaluating the electromagnetic logging measurements comprises evaluating the electromagnetic logging measurements with the primary classifier to classify the subterranean formation as either the 1D formation or the non-1D formation and evaluating the electromagnetic logging measurements with the secondary classifier to classify the subterranean formation as being one of a plurality of non-1D formation types when the primary classifier classifies the subterranean formation as the non-1D formation.

20. (canceled)
